(19) United States
(12) Patent Application Publication
(10) Pub. No.: US 2014/0292198 A1
(43) Pub. Date: Oct. 2, 2014

(54) MULTIPLE APPLICATION LED ILLUMINATION SYSTEM

(71) Applicant: American Machine Vision LLC, Salem, NH (US)

(72) Inventors: Brian C. Sanders, Salem, NH (US); Frederick A. Wright, Manchester, NH (US)

(73) Assignee: American Machine Vision LLC, Salem, NH (US)

(21) Appl. No.: 14/228,833

(22) Filed: Mar. 28, 2014

Related U.S. Application Data
(60) Provisional application No. 61/806,003, filed on Mar. 28, 2013.

(51) Int. Cl. F21K 99/00; H05B 33/08; F21V 29/00

(52) U.S. Cl. CPC F21K 9/10; F21V 29/004; F21K 9/50; F21K 9/17; H05B 33/0842
USPC 315/86; 362/218; 315/159

(57) ABSTRACT

An illumination system which houses LEDs on Printed Circuit Boards (PCB) in a lightweight, metal or plastic housing that can be configured as a stand-alone interior lighting fixture or retrofitted to a common two, three, or four tube fluorescent drop in a ceiling (troffer) light fixture. The system can also be configured as an emergency/security/night light.

This application claims benefit of U.S. Provisional Application Ser. No. 61/806,003, filed Mar. 28, 2013, pursuant to 35 USC §119(e).

### FIELD OF THE INVENTION

This invention relates to the field of light emitting diodes (LED) and, in particular, to an illumination system which houses LEDs on Printed Circuit Boards (PCB) in a lightweight, metal or plastic housing that can be configured as a stand-alone interior lighting fixture or retrofitted to a common two, three, or four tube fluorescent drop in ceiling (troffer) light fixture.

### BACKGROUND OF THE INVENTION

From the early discoveries in fluorite technology during the mid 19th century, hundreds of technological improvements in fluorescent illumination have been developed, introduced and currently continue to be implemented into all forms of fluorescent lighting. From its initial introduction into the global market in the 1930's, the fluorescent light fixture has become the standard for commercial and industrial lighting. In general these fixtures, in various sizes and shapes, were suspended by chain or cable and are still used in this configuration today.

In the 1950's the suspended 2′×4′ grid ceiling (T-bar) became a standard interior feature in newly constructed and renovated privately owned and government office buildings and remains the industry standard today. Troffer fluorescent fixtures, manufactured by Lightolier, Lithonia Lighting and others, are the standard light fixtures for T-bar ceilings with a conservative estimate of 300 million units in use in the ten major metropolitan areas of the U.S. alone.

A typical prior art troffer fluorescent light fixture consists of a steel enclosure, which provides a housing for the internal components and the fixture's structural support. The enclosure will normally have provisions for attaching support chains or cables to either relieve the weight of the fixture from the T-bar ceiling or independently suspend the fixture for applications where no T-bar ceiling is used. The enclosure also has provisions for a rudimentary latch and hinge system to accommodate a drop-down cover door that typically contains a diffuser panel. The diffuser panel is typically a plastic sheet with a prismatic pattern designed to spread the light output of the fixture.

Internally, a fluorescent troffer fixture manufactured in the last twenty years will have a ballast circuit to provide proper starting and operating power to the fluorescent tube lamps, a removable cover that conceals the ballast and associated wiring and sockets to accept the pins on the ends of the T10, T8, and T5 fluorescent tube lamps currently in production.

Fluorescent tube lighting fixtures produce significant amounts of heat from both the ballast circuit and the tube lamps. Ballasts can produce enough heat over time to discolor the steel housing. The fixtures produce sixty-cycle buzz or hum and as the lamps age the luminance output will deteriorate. The tubes will often develop an annoying flicker for extended periods of time before complete failure. Failed tubes must be disposed of in accordance with multiple federal and state regulations. Improper disposal will cause the uncontrolled release of hazardous compounds, including mercury, when the tube's outer glass shell is broken, resulting in environmental contamination and damage.

There is not found in prior art fluorescent tube lighting fixtures providing the availability of an integrated automatic security/night light or emergency lighting system.

Recent new fluorescing powder technologies accompanied by more innovative energy-efficient, frequency-controlled ballast designs and smaller diameter tubes have improved operation but luminance output and color temperature issues still impair performance of the prior art fluorescent fixtures.

Prior art LED troffer retrofit lighting fixtures have typically used high power 250 milliwatt (mW), 500 mW, and 1,000 mW LEDs. These LEDs are mounted single file on metal strips that run the length of the fixture or metal panels that form LED clusters. These LEDs can also be arranged in simulated tubes that mimic T10, T8, and T5 fluorescent lamps. These tubes contain internal power supplies and are powered either directly from the VAC supply power or from the output of the existing prior art ballast.

All prior art LED retrofit troffer fixtures and simulated tubes require metal heat sinks to dissipate the undesirable amount of energy wasting heat generated by these high power LEDs. All prior art LED retrofit troffer fixtures and simulated tubes require free air spacing above the fixtures to prevent heat concentration that can lead to premature LED or circuit failure.

Prior art T-bar LED lighting fixtures also use the high power LEDs. These fixtures can project light directly out of the LED optics or diffuse the LED output laterally through a diffuser panel often called ‘back lighting’. The light output from these fixtures can be useable, however, the fixtures produce substantial amounts of heat, requiring heat sinks and, in some fixtures, cooling fans. Expensive T-bar compatible products are not serviceable and would have to be discarded for if LED experienced failure.

In prior art wall mounted emergency lighting systems, light is projected out into the area to be lighted. The light is often projected into the eyes making it difficult to see. In a fire emergency situation where smoke is present this prior art light pattern can cause a “white out” condition as the light is reflected and diffused in all directions. Older versions of these prior art systems used incandescent bulbs, which limit the length of time the battery can produce light to two hours or less.

In prior art grow light systems it is common to see fixtures using 250 W and larger high-pressure sodium or metal halide lamps. These systems use a substantial amount of energy and produce a substantial amount of wasted heat. Prior art LED based grow lights require one or more integrated or supplemental cooling fans to dissipate the substantial amount of heat generated by the high powered LEDs. This further increases the amount of wasted energy consumed by these fixtures.

There is not found in the prior art, an LED illumination apparatus that can replace existing fluorescent light fixtures in multiple shapes and sizes and retrofit into existing troffer fluorescent light fixture housings; can operate on low voltage DC from either external plug-in or integrated hard wired power supplies; save 70% or more in energy usage depending on application; operate at temperatures that do not require heat sinks; produce light in either the cool or warm white segments of the visual spectrum; maintain 100% illumination output levels for up to 35,000 hours; can be fitted with an integrated Automatic Night/Security Lighting System; can be fitted with an integrated Emergency Battery Powered Lighting System and can be repaired or refurbished recovering all recyclable materials and producing a minimum of benign landfill waste.

### SUMMARY OF THE INVENTION

The present invention utilizes combinations of a LED array of specific length and width as the foundation for a versatile Multiple Application LED Illumination System.

It is an aspect of the invention that using the LED array in different quantities and layouts will produce Multiple Application LED Illumination Modules in various rectangular sizes.

It is an aspect of the invention to provide for multiple installation and application configurations for both general and high intensity lighting requirements.

It is an aspect of the invention to provide energy savings of 70% or more over prior art lighting fixtures used in similar applications.

It is another aspect of the invention to operate on low voltage 24 VDC that is 100% compatible with alternative renewable energy producing and storage systems.

It is still another aspect of the invention to provide operation on standard grid AC power using a power supply that is either integrated to the enclosure and hardwired to the supply AC power source or external to the fixture and plugged into standard AC power outlets.

It is an aspect of the invention that the enclosure will be either lightweight, formed metal or a molded or extruded plastic.

It is an aspect of the invention that no heat sinks are required.

It is another aspect of the invention that LED Illumination Modules, being available in various sizes, be used as both suspended, self contained lighting fixtures or as retrofit assemblies for prior art troffer fluorescent fixtures.

It is yet another aspect of the invention that the single array versions of the invention may be ‘daisy-chained’ to allow the operation of up to 8 fixtures on a common power supply and switch.

It is a further aspect of the invention that a fixture can be repaired on site or completely refurbished with a minimum of waste.

It is an aspect of the invention to provide an integrated Automatic Security/Night Light option.

It is an aspect of the invention to provide an integrated Automatic Emergency Light option.

### BRIEF DESCRIPTION OF THE DRAWINGS

FIG. 1 is an isometric drawing of one representative version of the preferred embodiment of components contained in the metal enclosure version of the Multiple Application LED Illumination System.

FIG. 2 is a drawing of the Standard and High Output LED Arrays used in the Multiple Application LED Illumination System.

FIG. 3A is an isometric drawing of the preferred embodiment of the components in medium wide configuration.

FIG. 3B is an isometric drawing of the preferred embodiment of the components in narrow configuration.

FIG. 3C is an isometric drawing of the preferred embodiment of the components in a high output wide configuration.

FIG. 3D is an isometric drawing of the preferred embodiment of the components in a standard output wide configuration.

FIG. 4 is an isometric drawing of the preferred embodiment of components in four different installations: a troffer retrofit use; a T-bar in a ceiling; a modular shelf mounted; and a free-hanging embodiment.

FIG. 5 is an isometric drawing of the preferred embodiment showing a daisy-chain configuration.

FIG. 6 is an isometric drawing of the preferred embodiment in an extruded plastic enclosure version.

FIG. 7 is an isometric drawing of the preferred embodiment of components identifying the LED Night Light and LED Emergency Light options.

### DETAILED DESCRIPTION OF THE INVENTION

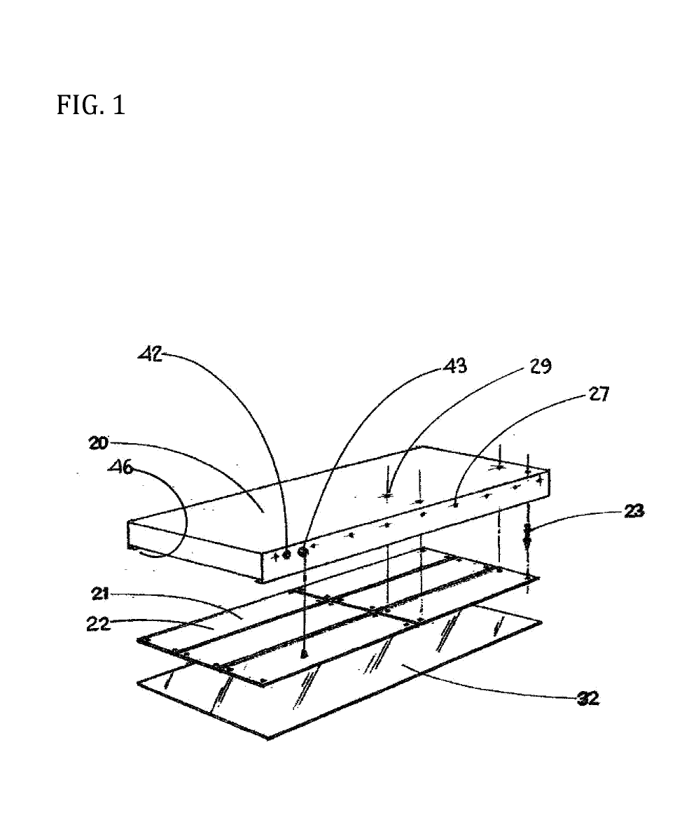

The invention is a versatile Multiple Application LED Illumination System that can be produced in multiple sizes for different applications but utilizing a common size LED array. Referring to FIG. 1, a typical Multiple Application LED Illumination Module will consist of a formed Metal Enclosure 20, either Standard LED Arrays 21 or High Output LED Arrays 22, nylon Standoffs 23, and an acrylic or polycarbonate Lens 32.

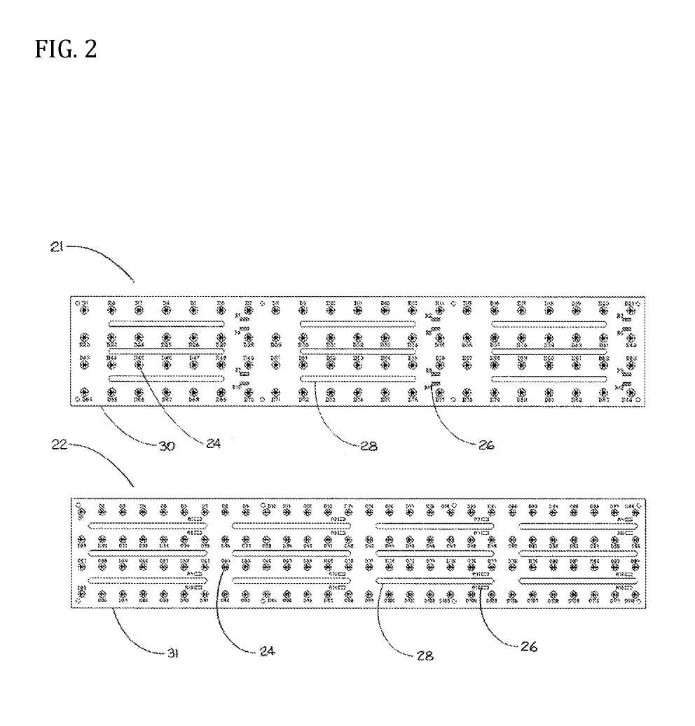

The Standard LED Array 21, as shown in FIG. 2, is a printed circuit board (PCB) 30 that is 0.060″ thick, 4.0″ wide, 21.0″ long with eighty four LEDs 24 of the type T-1 ¾ (5 mm) round. The LEDs 24 are arranged in a square grid pattern spaced at 1.0″ center to center. There are four columns of three groups of seven LEDs 24 for a total of twenty-one per column. Each group of seven LEDs 24 is wired in series with a 110 ohm current limiting Resistor 26. Ventilation Slots 28 in the PCB 30 are located between the columns.

The High Output LED Array 22, as shown in FIG. 2, is a PCB 31 that is 0.060″ thick, 4.0″ wide, 21.0″ long with one hundred twelve LEDs 24 of the type T-1 ¾ (5 mm) round. The LEDs 24 are arranged in a rectangular grid pattern. There are four columns 1.0″ apart center to center. The LEDs 24 in each column are spaced 0.75″ apart center to center. Each column contains four groups of seven LEDs 24 for a total of twenty eight per column. Each group of seven LEDs 24 is wired in series with a 110 ohm current limiting Resistor 26. Ventilation Slots 28 in the PCB 31 are located between the columns.

The LEDs 24 are manufactured by Kingbright Corporation. The Cool White version has the Kingbright part number WP7113VW1C-AMT. The Warm White version has the Kingbright part number WP7113VR41C-W2-AMT. These LED components can be used exclusively or in combination to provide the exact Kelvin level required for the application. Other manufacturers' LEDs having similar specifications and reliability characteristics can be used. The Resistors 26 are ¼ watt axial with 1% tolerance.

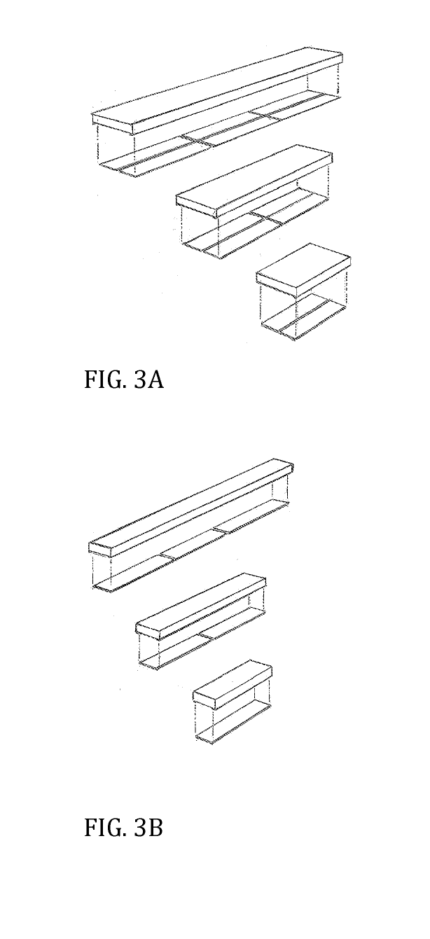

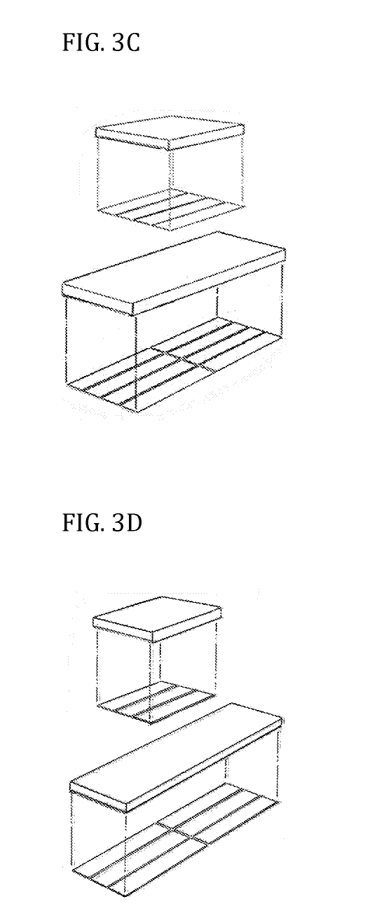

Referring to FIG. 1, the Metal Enclosure 20 is primarily a formed aluminum box 1.75″ deep. The box can also be made of steel. The Enclosure 20 width and length will vary depending on the number and layout of the Standard LED Array 21 or High Output LED Array 22 installed. The Standard 21 and High Output 22 LED Arrays are oriented with their 21″ length parallel to the length of the Enclosure 20 and are ‘grouped’ across the width of the Enclosure 20. Referring to FIG. 3, sizes include but are not limited to 43″ by 17″ to house eight arrays arranged in two groups of four, 22″ by 17″ to house four arrays arranged in one group of four, 43″ by 13″ to house six arrays arranged in two groups of three, 22″ by 13″ to house three arrays arranged in one group of three, 64″ by 9″ to house six arrays arranged in three groups of two, 43″ by 9″ to house four arrays arranged in two groups of two, 22″ by 9″ to house two arrays arranged in one group of two, 64″ by 5″ to house three arrays arranged in three groups of one, 43″ by 5″ to house two arrays arranged in two groups of one and 22″ by 5″ to house a single Standard LED Array 21 or High Output LED Array 22.

Also shown in FIG. 1, Holes 29 in the top of the Enclosure 20 accept snap in nylon PCB Standoffs 23. The positions of the Holes 29 dimensionally correspond to mounting holes in each LED array. The snap in nylon PCB Standoffs 23 secure the arrays inside the Enclosure 20 and allow for easy removal and replacement. Formed Channels 46 accept the Lens 32. Lens 32 will vary in length and width depending on the size of the Enclosure 20.

The Enclosure 20 has Holes 27 located on each long side near the upper edge. Holes 27 are used for both natural free air ventilation and as features for attaching hardware used to suspend or hard mount the invention.

Enclosure 20 also can have features to accept a Power Input Receptacle 42 and Pull Chain Switch 43 for applications that allow use of an external 24 VDC power supply.

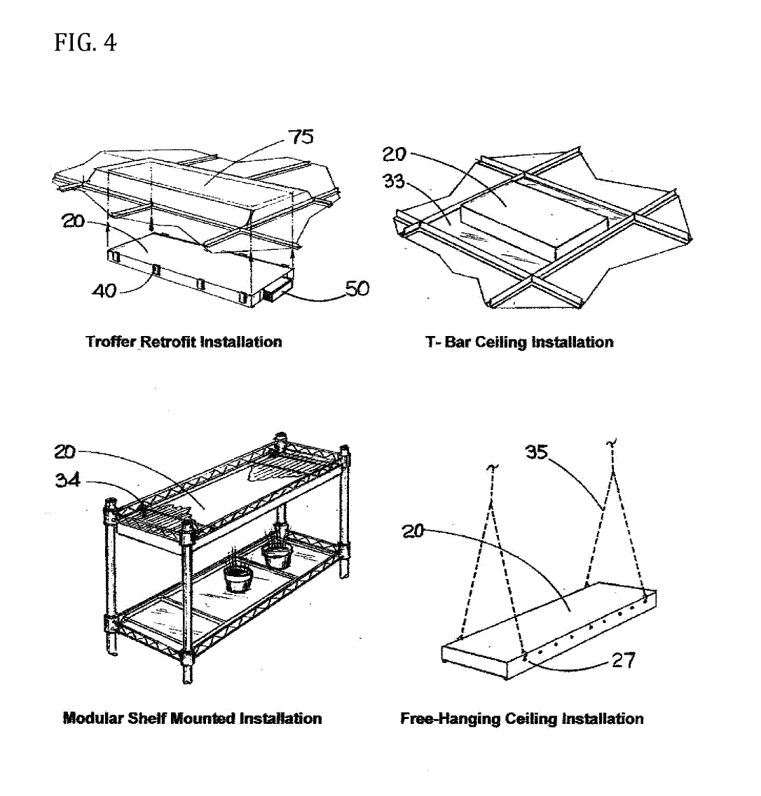

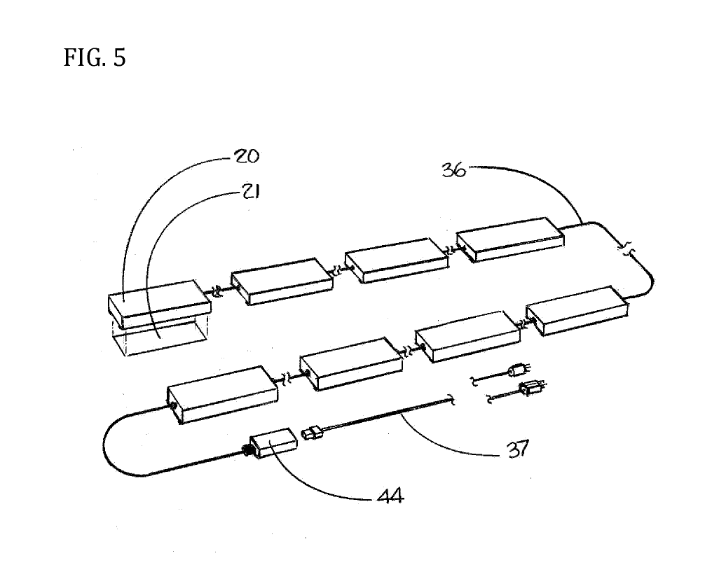

Referring to FIG. 4, Magnets 40 can be mounted using the Holes 27 in the Enclosure 20 for installing the invention in a Fluorescent Troffer Fixture 75 as a retrofit. To prepare a Fluorescent Troffer Fixture 75 for retrofit the tube lamps and ballast cover are removed. The input power wiring is detached from the ballast and the ballast and its associated wiring are removed. To install the retrofit the input wires to an Integrated 24 VDC Power Supply 50 are connected to the VAC power wiring in accordance with electrical code regulations. The invention can now be raised into the empty troffer fixture and attached using Magnets 40. The Magnets 40 provide for quick installation without tools or hardware, easy alignment, secure mounting, and easy service removal.

Holes 27 are also used for attaching an Adapter Frame 33 to the Enclosure 20 for installation into a 2′ by 4′ or 2′ by 2′ T-bar ceiling opening as a stand-alone OEM ceiling fixture. The Adapter Frame 33 is constructed of lightweight aluminum or vacuum formed plastic and has fixed outside dimensions depending on the size of the T-bar opening. The inside opening into which the Multiple Application LED Illumination Module will be attached will vary depending on the size of the Enclosure 20.

Holes 27 can be used to attach ‘S’ Hooks 34 or other generic hardware for securing the invention under a wire rack shelf. This configuration is one way to use a High Output LED Illumination Module as a vegetation grow light.

Holes 27 are also used for attaching hardware for suspending the invention. For example Chains with Hooks 35 are inserted into Holes 27 near each corner for hanging the invention from a ceiling.

For applications that either by design or by code require the power supply be hardwired to the VAC supply voltage, an Integrated 24 VDC Power Supply 50 is mounted to the end of the Enclosure 20 opposite the end the Lens 32 is inserted. The Integrated 24 VDC Power Supply 50 output is internally hardwired to the Standard 21 or High Output 22 LED Arrays using Wago Lever Nuts or similar NEMA accepted wire connectors. The lever nuts allow for easy connection during production and removal during servicing.

FIG. 5 shows the single LED array version of the invention daisy-chained for operation on a single External 24 VDC Power Supply 44 that connects to the supplied AC power via a standard plug-in Power Cord 37. Up to eight modules can be connected in series using Cable 36 and turned on and off using a single switch.

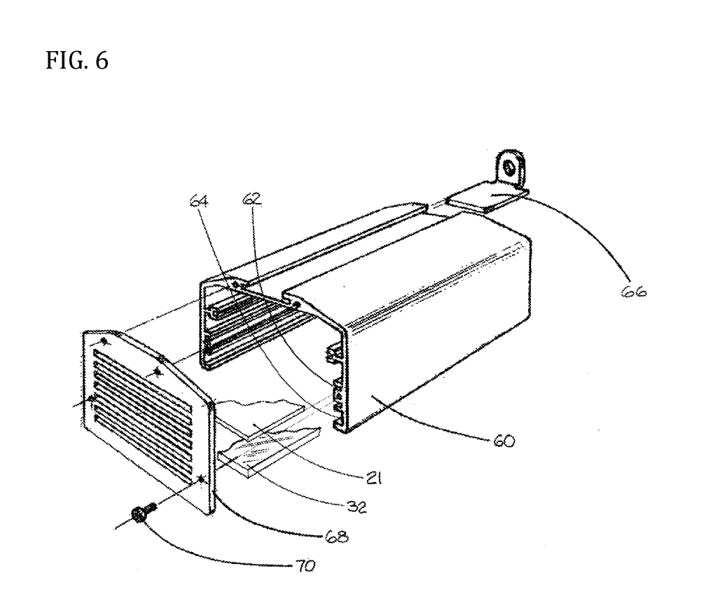

Referring to FIG. 6, the Plastic Enclosure 60 is an extruded part that will accept a single row of Standard LED Arrays 21. The length of the Plastic Enclosure 60 is determined by the number of LED Arrays 21 to a maximum of three arrays. The LED Array 21 slides into PCB Guides 62 molded into the extrusion. A Lens 32 slides into Lens Guides 64 molded into the extrusion. The Universal Mount Feature 66 installs into a feature on the spine, opposite the Lens 32. This feature allows for a variety of mounting hardware for multiple installation configurations. The LED Array 21, Lens 32, and any specialized mounting hardware are secured by molded or machined End Caps 68 screwed to each end of the extrusion. The End Cap Screws 70 are threaded into molded features in the extrusion. The Plastic Enclosure 60 is not designed for retrofit installations. Multiple Application LED Illumination Modules constructed with the Plastic Enclosure 60 can be powered using either the hard wired 24 VDC Power Supply 50 or External 24 VDC Power Supply 44.

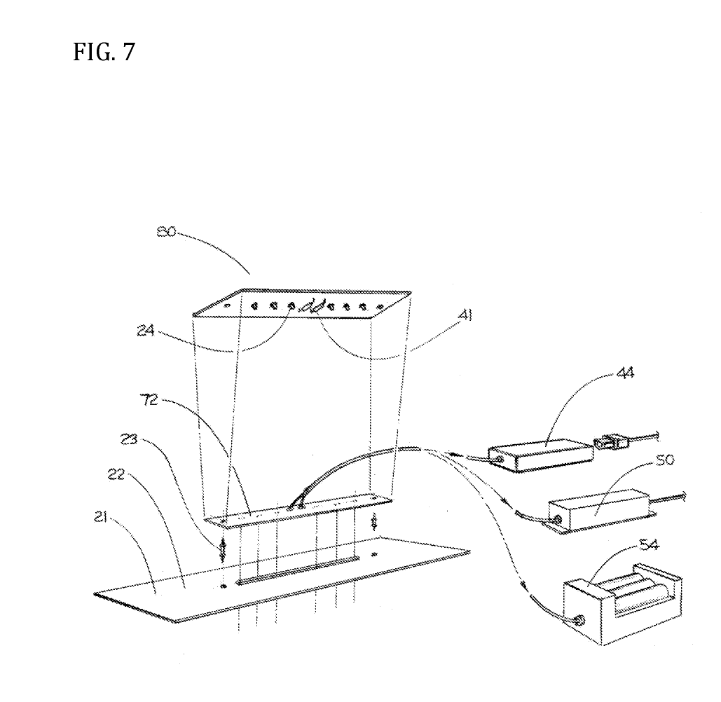

Referring to FIG. 7, adjunct Security/Night Light Module 80 consists of a PCB 72 that is 0.060″ thick, 0.5″ wide, 6.0″ long with six LEDs 24 of the type T-1 ¾ (5 mm) round. The LEDs 24 are arranged in a single row 0.75″ apart center to center and are divided into two groups of three. Each group of three is wired in series with a 120 ohm current limiting Resistor 41. The Resistors 41 are ¼ watt axial with 1% tolerance. The Security/Night Light Module 80 is mounted to an existing Standard LED Array 21 or High Output LED Array 22 using nylon snap in PCB Standoffs 23 and can be powered two ways. The module can be equipped with a photo sensor circuit and locally wired 12 VDC Power Supply 50. The module can also be gang wired with other modules to a central or common photo sensor and 12 VDC power source. In either configuration when the lights are turned off or the ambient light drops below the photo sensor's activation threshold the six LEDs 24 will be turned on. They will produce a beam of light directed down to the floor. In applications where security lighting would be desirable, multiple units of the present invention having integrated Security/Night Light Modules 80 installed would produce a usable amount of light when the main lights are turned off. Twenty Security/Night Light Modules 80 will use less supplied VAC power from the grid than a 50 Watt incandescent light bulb.

The adjunct Emergency Power Failure Light Module is identical to the Security/Night Light Module 80. It also consists of a PCB 72 that is 0.060″ thick, 0.5″ wide, and 6.0″ long with six LEDs 24 of the type T-1 ¾ (5 mm) round. The LEDs 24 are arranged in a single row 0.75″ center to center and are divided into two groups of three. Each group of three is wired in series with a 120 ohm current limiting Resistor 41. The Emergency Power Failure Light Module is also mounted to an existing Standard LED Array 21 or High Output LED Array 22 using nylon snap in PCB Standoffs 23 and can be powered two ways. The module can be equipped with an integrated power monitoring circuit and locally wired 12 VDC Rechargeable Battery Module 54 or it can be gang wired to a centralized power monitoring system with an incorporated 12 VDC battery backup power source. In either configuration, when power is lost, the six LEDs 24 will be turned on and produce a beam of light directed down to the floor. If arranged properly the beams of light can provide a path between obstacles and toward exits without the blinding conditions of prior art emergency lighting. The Emergency Power Failure Light Module will use only 50 mA of 12 VDC power allowing a 1.5 Ah battery to operate the light for 24 hours before reaching an 80% discharge level.

Although the present invention has been described with reference to certain preferred embodiments thereof, other versions are readily apparent to those of ordinary skill in the preferred embodiments contained herein.

What is claimed is:

1. An illumination module comprising:
a housing having a rectangular shape, a top, bottom, and four side panels with said side panels having a plurality of openings for ventilation and serving to attach hardware used to mount said module;
a rectangular printed circuit board having an array of ventilation slots provided therein and said printed circuit board dimensioned to be attached within said housing by means of standoffs thereby permitting easy removal and replacement;
an array of low voltage LEDs that are operable without the need for any heat sinks wherein said array is divided into a plurality of groups of said LEDs that are mounted on said printed circuit board and wherein each group of LEDs is connected in series with a current limiting resistor provided therein;
a transparent rectangular lens panel, dimensioned in accordance with the bottom of said housing and mounted therein to serve as a light diffuser; and
a low voltage power supply connected to said printed circuit board to power said LED array.

2. The illumination array of claim 1 further comprising s-hook means for suspending said module from a surface such as a ceiling or under a shelf or table, wherein said s-hook means is attached between said surface and at least two openings in at least two opposing side panels of said housing enabling said module to be suspended.

3. The illumination module of claim 1 further comprising magnetic means for retrofitting a fluorescent troffer lighting fixture wherein said magnetic means is mounted into at least two openings in said side panels of said housing and wherein said module is attached within the troffer lighting fixture once the lamps and ballast cover have been removed and the VAC power supply of the troffer lighting fixture is attached to said low voltage supply of said module thus providing for an easy and quick retrofit.

4. The illumination module of claim 1 further comprising an adapter frame means for installing said module within a standard T-bar ceiling opening, wherein said adapter means is attached between at least two openings in said side panels of said housing and the T-bar frame of the ceiling opening.

5. The illumination module of claim 1 wherein a plurality of said modules can be daisy-chained together in series and powered by a single external low voltage power supply for each module.

6. The illumination module of claim 5 wherein said plurality is up to 8 modules.

7. The illumination module of claim 1 wherein said low voltage power supply is 24 VDC.

8. The illumination module of claim 1 wherein said low voltage power supply is integrated within said module and wherein said module is connected to a standard AC outlet.

9. The illumination module of claim 1 further comprising an extruded plastic enclosure adapted to accept a single module, wherein module slides into said extruded enclosure via molded guides within said enclosure.

10. The illumination module of claim 9 further comprising a channel on the top of said enclosure.

11. The illumination module of claim 10 further comprising mounting means for attaching said enclosure to a structure, wherein said mounting means is slid into the channel on said enclosure.

12. The illumination module of claim 11 wherein said extruded plastic enclosure further comprises end caps at each end of said enclosure for holding in place said mounting means that has been slid into said channel.

13. The illumination module of claim 1 further comprising an emergency/security/night light module having a photo sensor, wherein said emergency/security/night light module is electrically connected to said printed circuit board turning on said illumination module when ambient light drops below a pre-determined threshold and turning off said illumination module when ambient light goes above a pre-determined threshold.

14. The illumination module of claim 13 wherein said emergency/security/night light module further comprises a battery back-up to operate said illumination module if electrical power to said illumination module is absent.
